(19) United States
(12) Patent Application Publication
(10) Pub. No.: US 2018/0365341 A1
(43) Pub. Date: Dec. 20, 2018

(54) Three-Dimensional Cad System Device, and Knowledge Management Method Used in Three-Dimensional Cad

(71) Applicant: Hitachi, Ltd., Chiyoda-ku Tokyo (JP)

(72) Inventor: Takashi YOKOHARI, Tokyo (JP)

(21) Appl. No.: 15/735,663

(22) PCT Filed: Jun. 24, 2015
(86) PCT No.: PCT/JP2015/068138

§ 371 Date: Dec. 12, 2017

(51) Int. Cl. G06F 17/50; G06N 5/02; G06F 17/30

(52) U.S. Cl. CPC G06F 17/50; G06N 5/02; G06F 2217/06; G06F 2217/04; G06F 2217/12; G06F 17/30946

(57) ABSTRACT

The present invention provides a three-dimensional CAD system device with which it is possible, as necessary during design work using three-dimensional CAD, to register and refer to knowledge information which corresponds to a three-dimensional CAD model which is a subject of the work. A three-dimensional CAD system device according to the present invention comprises a storage device which stores three-dimensional CAD data, and a computation processing device which executes design work on the basis of the three-dimensional CAD data. The three-dimensional CAD data includes knowledge-association data which associates knowledge data with a three-dimensional CAD object. During the design work, the computation processing device stores the knowledge-association data in the three-dimensional CAD data, and, on the basis of the knowledge-association data which is stored in the three-dimensional CAD data, queries the knowledge data which is associated with the three-dimensional CAD object.

### TECHNICAL FIELD

The present invention relates to a three-dimensional computer-aided design (CAD) system device having a knowledge management capability and a knowledge management method used in three-dimensional CAD.

### BACKGROUND ART

In the manufacturing industry, worldwide cooperative design at domestic and overseas bases is increasing. Accordingly, in the course of changing the design based on three-dimensional CAD (Computer Aided Design) data, there is a demand for sharing, with others, design knowledge information serving a basis of the design change such as a shape change, a material change, a part change for cost reduction, strength improvement, performance upgrading, and the like while leaving it as a simple operation procedure. In response to such a demand, the techniques described in PTLs 1 to 3 are known in the art.

In the technique described in PTL 1, the knowledge and the three-dimensional CAD model are stored in a database by associating them using a unique management number, and the associated knowledge is searched and displayed on the basis of a feature point of the three-dimensional CAD model. In this technique, the knowledge is associated with the feature point (associated point of the knowledge) of the three-dimensional CAD model on a knowledge management device while the three-dimensional CAD model is loaded on the knowledge management device and is displayed on a viewer, which is a function of the knowledge management device.

In the technique described in PTL 2, document information including trouble cases and precautions stored in an engineering knowledge database is associated with all or a part of disassembled three-dimensional CAD images, and this information is automatically displayed. This technique relates to an electronic manual regarding machine manufacturing, processing, and assembly works, and is applied to a three-dimensional electronic manual in which the three-dimensional CAD model can be captured and displayed.

In the technique described in PTL 3, as a shape element of the three-dimensional CAD model is selected, a knowledge base list presentation screen is displayed, and a knowledge base including knowledge relating to the shape element is displayed as a list. In this technique, a part is divided into a plurality of shape elements, and a shape element name is allocated to each part. In addition, knowledge regarding shape constraint rules and manufacturability is stored in the knowledge base. When any one of the shape elements is selected on the three-dimensional CAD system, the knowledge base is searched on the basis of the shape element name, and the searched knowledge regarding the shape rule and manufacturability is displayed on the screen of the CAD system device.

### CITATION LIST

### Patent Literature

PTL 1: JP 2013-097743 A
PTL 2: JP 2006-268807 A
PTL 3: JP 11-296566 A

### SUMMARY OF INVENTION

### Technical Problem

In the techniques described in PTL 1 and PTL 2, design knowledge information is registered and referenced by a system for knowledge management, and it is difficult to register and reference design knowledge using the three-dimensional CAD system at any time during designing. In addition, in the technique described in PTL 3, while the design knowledge information can be referenced on the screen of the CAD system device, the design knowledge information is registered in the knowledge base in advance. Therefore, in the technique described in PTL 3, it is difficult to register and reference the design knowledge using the three-dimensional CAD system at any time during designing. Therefore, these techniques of the related art fail to sufficiently respond to the demand for sharing the design knowledge information with others while leaving it as a simple operation procedure.

In this regard, the present invention provides a three-dimensional CAD system device and a knowledge management method capable of registering and referencing knowledge information corresponding to a three-dimensional CAD model as a work target at any time during a design work based on a three-dimensional CAD.

### Solution to Problem

In order to address the aforementioned problems, according to the present invention, there is provided a three-dimensional CAD system device including: a storage device that stores three-dimensional CAD data; and a computation processing device that executes a design work on the basis of the three-dimensional CAD data, in which the three-dimensional CAD data includes knowledge association data that associates knowledge data with a three-dimensional CAD object, and the computation processing device stores the knowledge association data in the three-dimensional CAD data during a design work and references the knowledge data associated with the three-dimensional CAD object on the basis of the knowledge association data stored in the three-dimensional CAD data.

In order to address the aforementioned problems, according to the present invention, there is provided a knowledge management method used in three-dimensional CAD, including: a first step of designating a three-dimensional CAD object in three-dimensional CAD data during design; a second step of designating knowledge data associated with the three-dimensional CAD object designated in the first step; and a third step of storing, in the three-dimensional CAD data, knowledge association data that associates the three-dimensional CAD object designated in the first step with the knowledge data designated in the second step.

### Advantageous Effects of Invention

According to the present invention, it is possible to register and reference the knowledge information corresponding to the three-dimensional CAD model as a work target at any time during a design work based on a three-dimensional CAD.

Other objects, configurations, and effects may become apparent by reading the following description of the embodiments.

### BRIEF DESCRIPTION OF DRAWINGS

FIG. 1 illustrates a whole configuration of a three-dimensional CAD system device according to an embodiment of the invention.

FIG. 2 illustrates a process flow executed by the three-dimensional CAD system device and an exemplary screen display.

FIG. 3 is a conceptual diagram for expressing the three-dimensional CAD model in the three-dimensional CAD system.

FIG. 4 illustrates an exemplary knowledge association process flow.

FIG. 5 illustrates an exemplary knowledge reference process flow.

FIG. 6 illustrates an exemplary knowledge association control screen.

FIG. 7 illustrates a data input/output operation during a knowledge association process in a database.

FIG. 8 illustrates a data input/output operation during a knowledge reference process in a database.

FIG. 9 illustrates a data structure of a three-dimensional CAD object.

FIG. 10 is an exemplary three-dimensional CAD model that shares the same parts.

### DESCRIPTION OF EMBODIMENTS

Embodiments of the invention will now be described with reference to the accompanying drawings. Note that, in each drawing, like reference numerals denote like elements.

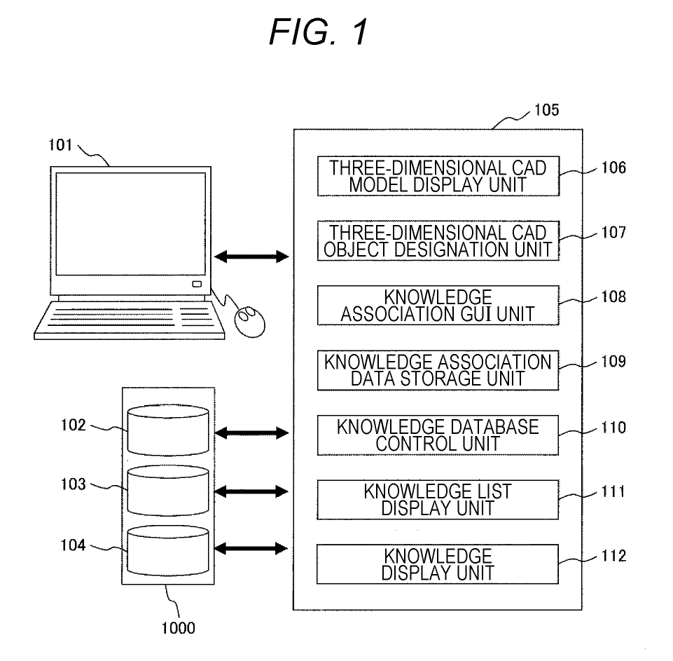

FIG. 1 illustrates a whole configuration of a three-dimensional computer-aided design (CAD) system device according to an embodiment of the invention.

The three-dimensional CAD system device according to this embodiment includes a computing database 101. The computing database 101 includes a display as a display device, an input/output device such as a keyboard or a mouse, and a storage device such as a memory or a storage unit. By executing a program, a process of the three-dimensional CAD system and a registration and reference process for design knowledge data corresponding to a three-dimensional CAD model as a processing target are performed. Such processes are executed by a computation processing device 105 such as a micro processing unit (MPU) provided in the computing database 101.

In FIG. 1, an element 102 is a three-dimensional CAD database that accumulates three-dimensional CAD data, and an element 103 is a knowledge database that accumulates design knowledge data (hereinafter, referred to as “knowledge data”). The design knowledge information indicated by the design knowledge data includes documents regarding design such as a basis of the design change (such as a shape change, a material change, and a part change), a design standard, a design rule, and a CAE analysis result, and documents regarding manufacturability such as fabrication/assembly methods. An element 104 is a knowledge association database that accumulates knowledge association data that associates three-dimensional CAD objects and knowledge data. Such databases 102, 103, and 104 are stored in a storage device 1000 provided in the computing database 101.

The three-dimensional CAD object used by the three-dimensional CAD system device according to this embodiment in the course of execution of the design work includes three-dimensional CAD data accumulated in the three-dimensional CAD database 102 and the knowledge association data accumulated in the knowledge association database 104. That is, the three-dimensional CAD object according to this embodiment stores the knowledge association data.

In FIG. 1, the computation processing device 105 executes the process of the three-dimensional CAD system and the registration and reference process of the knowledge data corresponding to the three-dimensional CAD model as a processing target using the databases 102, 103, and 104 stored in the storage device 1000. For this reason, the computation processing device 105 has a plurality of functional units, that is, a three-dimensional CAD model display unit 106, a three-dimensional object designation unit 107, a knowledge association GUI unit 108, a knowledge association data storage unit 109, a knowledge database control unit 110, a knowledge list display unit 111, and a knowledge display unit 112. Note that, according to this embodiment, the computation processing device 105 is operated as each functional unit 106 to 112 by reading and executing a predetermined program.

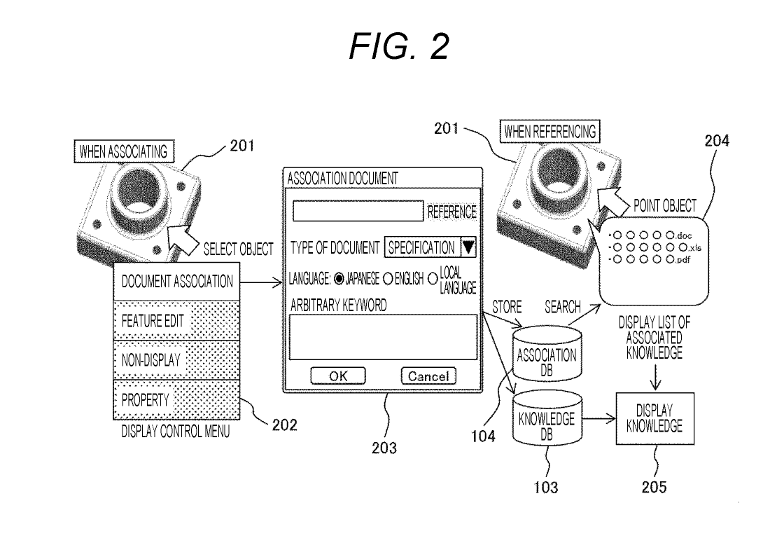

FIG. 2 illustrates a process flow as a whole executed by the three-dimensional CAD system device according to this embodiment using the computation processing device 105 and an exemplary screen display in the display device. Note that an element 201 of FIG. 2 is an exemplary three-dimensional CAD model.

First, an arbitrary region of the three-dimensional CAD model (object of the three-dimensional CAD model) associated with knowledge is designated by operating the input device. As a result, a control menu 202 is displayed. The control menu 202 also includes typical commands of the three-dimensional CAD system (such as FEATURE EDIT, NON-DISPLAY, and PROPERTY). If a knowledge association command (“DOCUMENT ASSOCIATION” of the control menu 202) is selected out of the control menu 202, the knowledge association screen 203 is displayed. The subsequent process is different between a case where new knowledge is added and a case where existing knowledge is reused. Here, the case where new knowledge is added will be described. The case where existing knowledge is reused will be described below.

On the displayed screen 203, a document regarding the knowledge to be added is designated. Note that, according to this embodiment, a type of the document, a language, and a keyword can also be designated on the same screen 203. The data on the document designated on the screen 203 is stored in the knowledge database 103 (FIG. 1). In this case, an identifier (knowledge ID) included in the stored document data is acquired, and knowledge association data (for example, a set of the three-dimensional CAD object ID and the knowledge ID associated with each other) that associates a three-dimensional CAD object ID (an identifier for uniquely identifying an assembly, a subassembly, a part, and an object such as a solid or a facet included in the part constituting the three-dimensional CAD model) corresponding to the region of the three-dimensional CAD model designated in advance and the knowledge ID is created and stored in the knowledge association database 104. In the knowledge data reference process, when the region of the three-dimensional CAD model 201 associated with the knowledge is designated by the input device, a list presentation 204 of the associated knowledge is displayed, and a knowledge presentation 205 indicating the knowledge designated by a user using the input device out of the list presentation 204 is displayed (205).

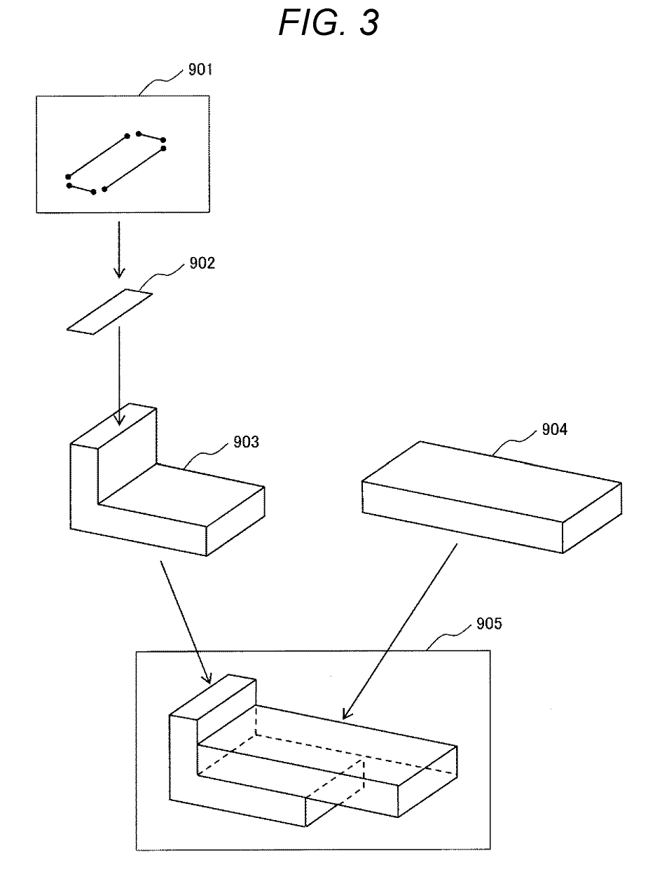

Here, an object included in the three-dimensional CAD model will be described with reference to FIG. 3.

FIG. 3 is a conceptual diagram that expresses a three-dimensional CAD model in a three-dimensional CAD system.

As illustrated in FIG. 3, shape elements constituting a three-dimensional CAD model include points, line segments obtained by linking the points, facets obtained by combining several line segments, and a solid obtained by combining several facets. An element 901 is an example of a plurality of line segments, and an element 902 is an example of the facet obtained by combining the line segments. An element 903 is an example of the solid obtained by combining a plurality of facets including the facet 902. In the three-dimensional CAD system, such a solid may be referred to as a part (component). Therefore, the terminology “part” means a “solid” hereinafter. An element 904 is another example of the part. An element 905 is a combination of the parts. This is referred to as “assembly data” (or simply “assembly”) in the three-dimensional CAD system. A larger amount of assembly data may be created by combining a plurality of assembly data in some cases. In this case, a small amount of the original assembly data will be referred to as a “subassembly.”

The three-dimensional CAD system assigns a unique identifier to each of the points, the line segments, the facets, the subassemblies, and the assemblies. According to this embodiment, this will be referred to as a “three-dimensional CAD object ID.”

A knowledge association process and a knowledge reference process according to this embodiment will now be described. Such processes are executed as the computation processing device 105 of FIG. 1 appropriately operates each unit 106 to 112.

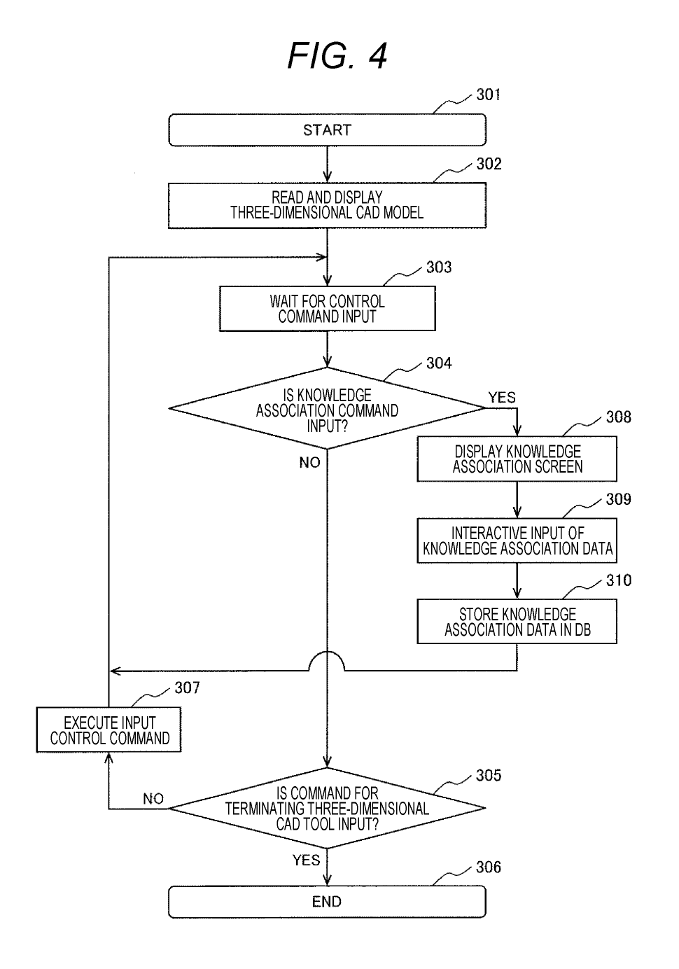

FIG. 4 illustrates an exemplary flow of the knowledge association process according to this embodiment. The knowledge association process according to this embodiment is executed on the three-dimensional CAD system. The three-dimensional CAD system starts the process in an event-driven manner (step 301) and reads and displays the three-dimensional CAD model (step 302). Then, the three-dimensional CAD system waits for an input for a certain command from an operator (step 303), and evaluates the input control command to determine whether or not it is the knowledge association command (step 304). If it is determined that the input control command is not the knowledge association command (NO in step 304), it is determined whether or not the input control command is a command for terminating the three-dimensional CAD tool (step 305). If the input control command is the command for terminating the three-dimensional CAD tool (YES in step 305), the process of the three-dimensional CAD system is terminated (step 306). If the input control command is not the command for terminating the three-dimensional CAD tool (NO in step 305), the input control command is executed (step 307), and then, the process returns to step 303. If it is determined that the knowledge association command is input in step 304 (YES in step 304), the knowledge association screen is displayed (step 308). Then, an interactive input of the knowledge association data is executed (step 309), and the knowledge association data are accumulated in the knowledge association database 104 (FIG. 1) (step 310). Then, the process returns to step 303 and waits for a control command input.

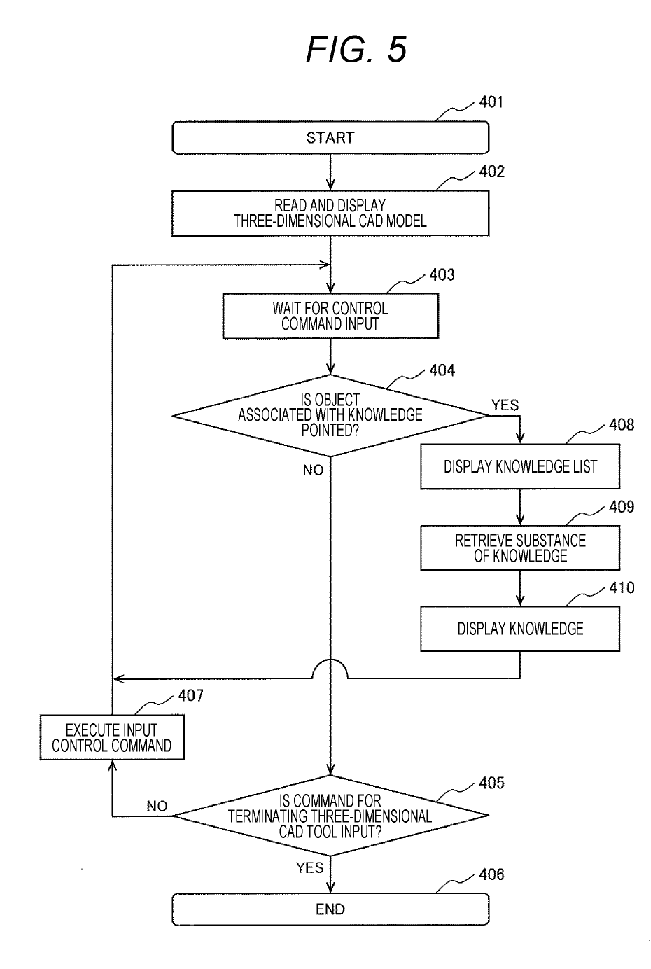

FIG. 5 is an exemplary flow of the knowledge reference process according to this embodiment. Similarly, the knowledge reference process is also executed on the three-dimensional CAD system. Note that steps 401 to 403 and 405 to 407 correspond to steps 301 to 303 and 305 to 307, respectively, in FIG. 4, and they will not be described repeatedly.

As illustrated in FIG. 5, while the three-dimensional CAD model is displayed, it is determined whether or not the three-dimensional CAD object is pointed (designated) by the input device (step 404). If it is determined that the three-dimensional CAD object is pointed, the knowledge association data representing that the pointed three-dimensional CAD object and the knowledge data are associated with each other is acquired from the knowledge association database 104, and a list of the associated knowledge is displayed on the basis of the knowledge ID indicated by this knowledge association data (step 408). If an operator selects specific knowledge on the knowledge list presentation, a substance of the selected knowledge (details of the content) is retrieved from the knowledge database 103 on the basis of the knowledge ID of the selected knowledge (step 409), and the content of the retrieved knowledge is displayed on the display device (step 410). Then, the process returns to step 403, and waits for a control command input.

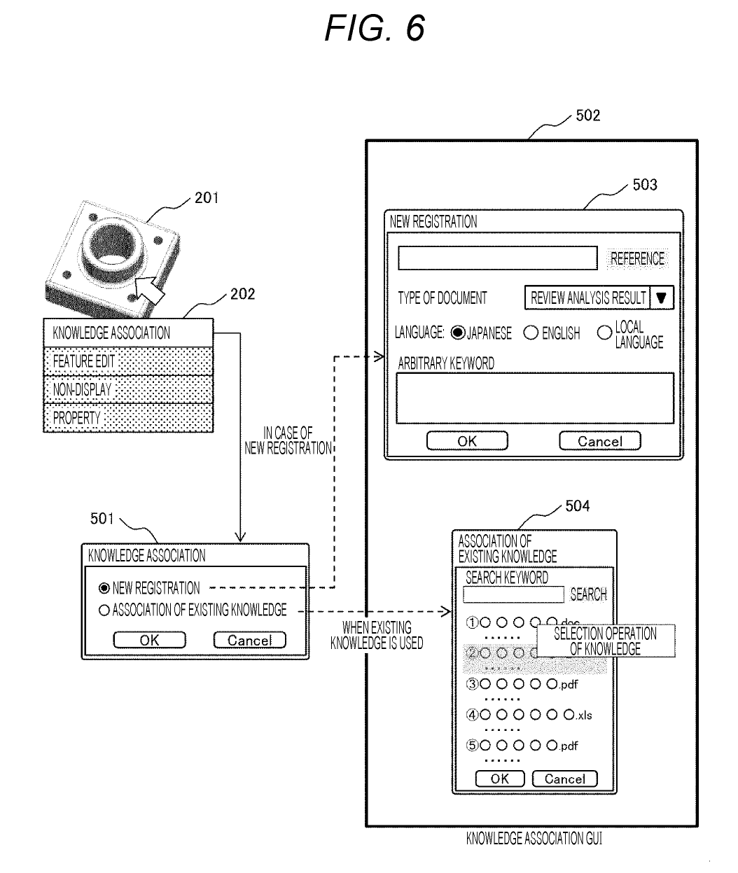

FIG. 6 illustrates an exemplary knowledge association control screen. FIG. 6 is obtained by dividing FIG. 2 schematically illustrated in advance into a case where new knowledge is added and a case where existing knowledge is reused and detailing them.

As illustrated in FIG. 6, as an arbitrary region (three-dimensional CAD object) of the three-dimensional CAD model 201 displayed on the screen is designated, the control menu 202 is displayed. When a command for the knowledge association is selected, a screen 501 for allowing an operator to select whether knowledge is newly registered or existing knowledge is associated is displayed. In response to selection on the screen 501, the knowledge association GUI unit (108 in FIG. 1) outputs an interactive input screen 502 including the knowledge association GUI to the display device. When new registration is selected on the screen 501, a screen 503 for newly registering knowledge is displayed as the interactive input screen 502. In order to facilitate search and classification of the knowledge, the screen 503 according to this embodiment also provides a function of selecting a document type, a function of selecting a description language of a document, and a function of inputting an arbitrary keyword are also provided in addition to designation of a document location. If it is selected that existing knowledge is associated on the screen 501, an existing knowledge association screen 504 is displayed as the interactive input screen 502. If a search keyword is input on the screen 504, a list of the knowledge indicated by the knowledge data searched from the knowledge database 103 is displayed. Therefore, an operator selects specific knowledge out of them.

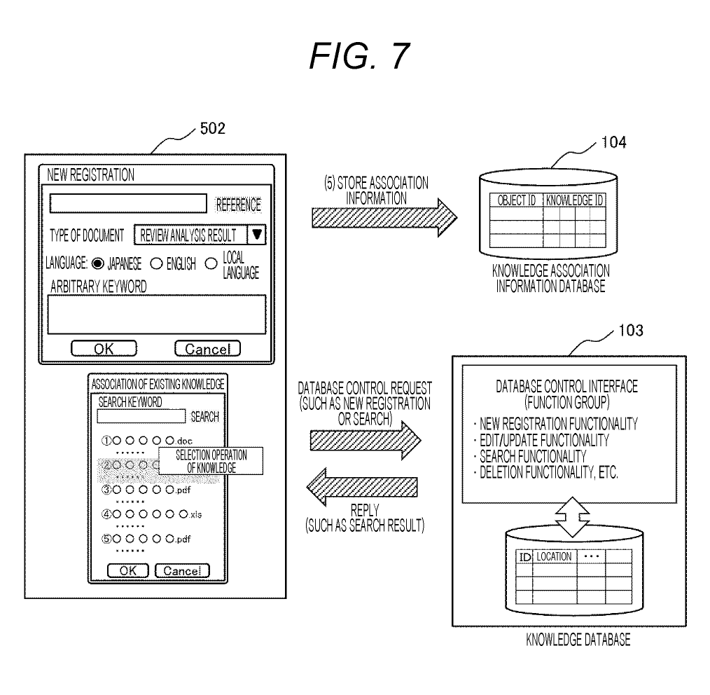

FIG. 7 illustrates a data input/output operation during the knowledge association process in the database according to this embodiment. Even when any one of the new registration of knowledge or the reuse registration of existing knowledge is selected on the interactive input screen 502 for knowledge association, the knowledge ID is acquired from the knowledge database 103 and is stored in the knowledge association database 104 as the knowledge association data by associating the three-dimensional CAD object ID of the designated region of the three-dimensional CAD model with the knowledge ID of the knowledge to be registered. In order to associate a plurality of pieces of knowledge with a single three-dimensional CAD object, a data table of the knowledge association database 104 is provided with fields for storing a plurality of knowledge IDs. In addition, the knowledge database 103 has a general interface for registration, editing, search, deletion, and the like for the database operation to provide a function of inputting the knowledge data to be registered or outputting knowledge data as a search result for a database operation request from the interactive input screen 502. Note that the knowledge database 103 may store only the data representing a location of the knowledge data without storing the knowledge data representing the substance of the knowledge (such as a document).

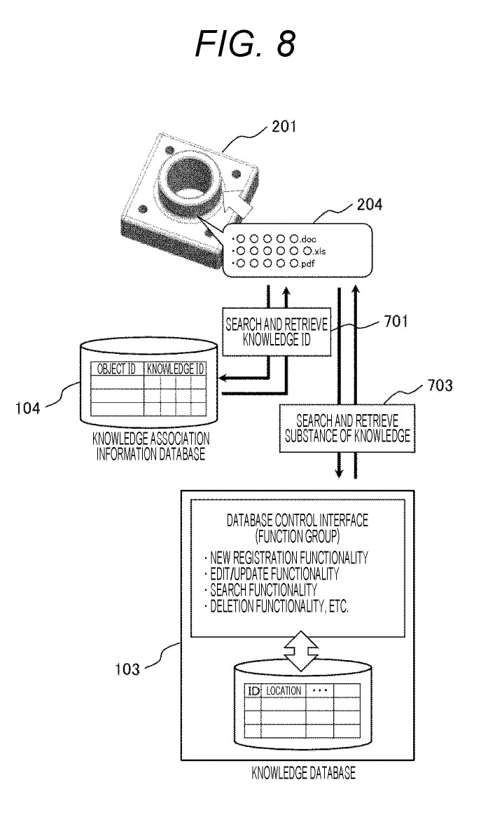

FIG. 8 illustrates a data input/output operation during the knowledge reference process in the database according to this embodiment. If an arbitrary region of the three-dimensional CAD model 201 displayed on the screen is designated by the input device, the knowledge association data including the three-dimensional CAD object ID of the designated region is searched in the knowledge association database 104, and the knowledge ID associated with the three-dimensional CAD object ID is acquired from the searched knowledge association data (input/output 701). The knowledge list presentation 204 is displayed on the basis of the acquired knowledge ID. Note that, if there is no associated knowledge, the knowledge list presentation 204 is not displayed. However, a message indicating that there is no associated knowledge may be displayed. When specific knowledge is selected from the displayed knowledge list presentation 204, a location of the knowledge data (document file) of the selected knowledge is acquired from the knowledge database 103 on the basis of the knowledge ID of the selected knowledge, and the substance (document) of the knowledge is displayed on the operation screen (input/output 703).

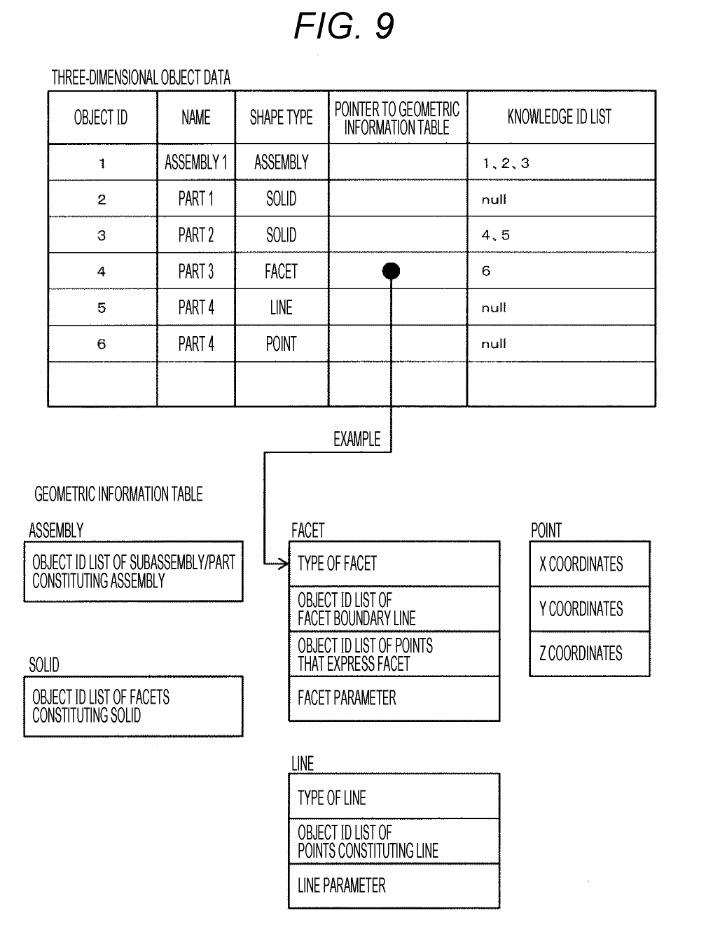

Next, a data structure of the three-dimensional CAD object according to this embodiment in which a knowledge registration and reference functionality is embedded on the three-dimensional CAD system will be described with reference to FIG. 9.

FIG. 9 illustrates a data structure of the three-dimensional CAD object according to this embodiment. The data structure of FIG. 9 is a whole data structure including the three-dimensional CAD database 102 and the knowledge association database 104. Note that the knowledge ID may also be directly embedded in the three-dimensional CAD object. In this case, the knowledge association database 104 is included in the three-dimensional CAD database 102 that accumulates the three-dimensional CAD object to form a single database. As a result, it is possible to expedite the knowledge registration/reference process.

As illustrated in FIG. 9, the three-dimensional CAD object according to this embodiment has an object ID, a name of the region of the three-dimensional CAD model, a shape and type of the region, and data regarding a structure of the three-dimensional ADC model including a pointer for referencing a geometric information table as illustrated in FIG. 9. The three-dimensional CAD object data according to this embodiment includes a list of the knowledge IDs associated with the object IDs. That is, in the data structure of the three-dimensional CAD object according to this embodiment, the knowledge association data is stored in the three-dimensional CAD object as illustrated in FIG. 9. Using the three-dimensional CAD object having such a data structure, it is possible to register and reference the design knowledge information corresponding to the three-dimensional CAD model as a work target at any time during a design work based on the three-dimensional CAD.

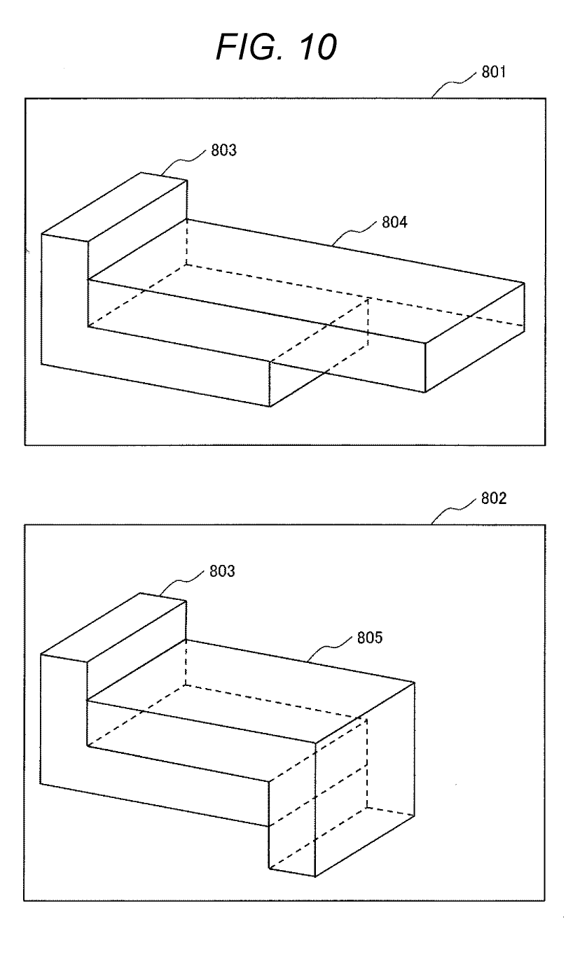

Next, advantageous effects obtained by embedding the knowledge registration and reference functionality in the three-dimensional CAD system according to this embodiment will be described with reference to FIG. 10 in comparison with the related art.

FIG. 10 illustrates an exemplary three-dimensional CAD models that share the same parts. Elements 801 and 802 are assemblies. Elements 803, 804, and 805 are parts. First, the assembly 801 including the parts 803 and 804 is created on the three-dimensional CAD system. At this time, knowledge association is performed for the part 803. In this case, after creating the assembly 801, the knowledge associated with the part 803 may be referenced by another assembly 802 including the parts 803 and 805 created on the three-dimensional CAD system.

In comparison, in the related art in which the assembly data is read by a system separate from the three-dimensional CAD system that creates the assembly data, and knowledge is added thereto, IDs unique to this system are allocated to the assembly data or a plurality of parts of the assembly data. For this reason, even when a common part 803 is used as in the assemblies 801 and 802 described above, different IDs are allocated to the part 803 of the assembly 801 and the part 803 of the assembly 801. Therefore, the knowledge associated with the part 803 of the assembly 801 is not spontaneously inherited to the part 803 of the assembly 802.

According to this embodiment, the knowledge ID is associated with the three-dimensional CAD object ID of the part 803 allocated by the three-dimensional CAD system. Therefore, the knowledge associated with the part 803 of the assembly 801 is inherited to the part 803 of the assembly 802. Therefore, the knowledge associated with the part 803 of the assembly 801 can be referenced by designating the part 803 of the assembly 802.

As described above, according to this embodiment, it is possible to register and reference the knowledge corresponding to the three-dimensional CAD model as a processing target at any time during the processing of the three-dimensional CAD system while an operator operates the three-dimensional CAD system.

According to this embodiment, in a design work based on the three-dimensional CAD system, it is possible to easily associate design knowledge such as documents regarding design (such as a basis of the design change such as a shape change, a material change, and a part change, a design standard, a design rule, and a CAE analysis result) and documents regarding manufacturability such as fabrication/assembly methods with various objects such as an assembly, a subassembly, a part, or a solid or facets included in the part constituting the three-dimensional CAD model. In addition, it is possible to easily search and reference the knowledge.

According to this embodiment, the design document is associated with the three-dimensional CAD data in a simple sequence, and the associated design document can be easily referenced. For this reason, it is possible to share design knowledge using the three-dimensional CAD data.

In addition, according to this embodiment, since the design document data (knowledge data) is directly associated with the assembly data or the part data, the knowledge registration and reference functionality can be embedded as one of the functionalities of the three-dimensional CAD system. For this reason, when the assembly or part associated with the knowledge is incorporated into other products, the knowledge associated in advance can be referenced during a subsequent design work.

Note that the present invention is not limited to the aforementioned embodiments, and various modifications may also possible. For example, although the aforementioned embodiments have been described in details for facilitating understanding of the present invention, it is not necessary to provide all of the elements described above. In addition, any addition, deletion, or substitution may be possible for a part of the elements of each embodiment.

For example, the computing database of the three-dimensional CAD system device may be a personal computer (PC) or a work station (WS). In addition, the CAD system is not limited to a mechanical design, but may also be applied to other three-dimensional structure design works such as an architectural design.

### REFERENCE SIGNS LIST

101 . . . computing database, 102 . . . three-dimensional CAD database, 103 . . . knowledge database, 104 . . . knowledge association database, 105 . . . computation processing device, 106 . . . three-dimensional CAD model display unit, 107 . . . three-dimensional CAD object designation unit, 108 . . . knowledge association GUI unit, 109 . . . knowledge association data storage unit, 110 . . . knowledge database control unit, 111 . . . knowledge list display unit, 112 . . . knowledge display unit, 201 . . . three-dimensional CAD model, 202 . . . control menu, 203 . . . knowledge association screen, 204 . . . knowledge list presentation, 501 . . . screen, 502 . . . interactive input screen, 503, 504 . . . screen, 801, 802 . . . assembly data, 803, 804, 805 . . . part, 1000 . . . storage device

1. A three-dimensional computer-aided design (CAD) system device comprising:
a storage device that stores three-dimensional CAD data; and
a computation processing device that executes a design work on the basis of the three-dimensional CAD data,
wherein the three-dimensional CAD data includes knowledge association data that associates knowledge data with a three-dimensional CAD object, and
the computation processing device stores the knowledge association data in the three-dimensional CAD data during a design work and references the knowledge data associated with the three-dimensional CAD object on the basis of the knowledge association data stored in the three-dimensional CAD data.

2. The three-dimensional CAD system device according to claim 1, wherein the knowledge association data includes a three-dimensional CAD object ID and a knowledge ID associated with each other.

3. The three-dimensional CAD system device according to claim 2, wherein a plurality of the knowledge IDs are associated with the three-dimensional CAD object ID.

4. The three-dimensional CAD system device according to claim 1, wherein the three-dimensional CAD object is any one of points, line segments, facets, parts, subassemblies, and assemblies.

5. The three-dimensional CAD system device according to claim 1, wherein the knowledge data represents a document regarding design or manufacturability.

6. The three-dimensional CAD system device according to claim 1, wherein the storage device stores a three-dimensional CAD database that accumulates the three-dimensional CAD data, a knowledge database that accumulates the knowledge data, and a knowledge association database that accumulates the knowledge association data.

7. The three-dimensional CAD system device according to claim 1, wherein the knowledge association data is embedded in the three-dimensional CAD object.

8. The three-dimensional CAD system device according to claim 7, wherein the storage device stores a three-dimensional CAD database that accumulates the three-dimensional CAD data and a knowledge database that accumulates the knowledge data.

9. The three-dimensional CAD system device according to claim 1, further comprising a display device that displays the three-dimensional CAD data,
wherein, if the three-dimensional CAD object of the three-dimensional CAD data displayed on the display device is designated, the display device displays a screen for designating knowledge data associated with the three-dimensional CAD object, and
the computation processing device stores, in the three-dimensional CAD data, the knowledge association data that associates the designated three-dimensional CAD object with the knowledge data designated on the screen.

10. A knowledge management method used in three-dimensional computer-aided design (CAD), comprising:
a first step of designating a three-dimensional CAD object in three-dimensional CAD data during design;
a second step of designating knowledge data associated with the three-dimensional CAD object designated in the first step; and
a third step of storing, in the three-dimensional CAD data, knowledge association data that associates the three-dimensional CAD object designated in the first step with the knowledge data designated in the second step.
